(19) United States
(12) Patent Application Publication
(10) Pub. No.: US 2006/0157523 A1
(43) Pub. Date: Jul. 20, 2006

(54) Bicycle carrier which can be attached to a vehicle

(76) Inventors: Frederic Girod, Nice (FR); Olivier Lallement, Nice (FR)

Correspondence Address: YOUNG & THOMPSON, 745 SOUTH 23RD STREET, 2ND FLOOR, ARLINGTON, VA, 22202, US

(21) Appl. No.: 10/512,158

(22) PCT Filed: Mar. 13, 2003
(86) PCT No.: PCT/FR03/00798

§ 371 Date: Mar. 6, 2006

(30) Foreign Application Priority Data
Mar. 25, 2002 (FR) 02/03660
Oct. 8, 2002 (FR) 02/12448

(51) Int. Cl. B60R 11/00; B60R 9/00

(52) U.S. Cl. 224/497; 224/924

(57) ABSTRACT

The invention relates to a bicycle carrier comprising a support structure (1) for at least one bicycle, able to be attached to a vehicle by two anchoring means each of which are disposed at the end of a branch (2a, 2b, 3a, 3b) connected on the other end thereof to the support structure (1), at least one branch (2a, 2b) is pivotably mounted in relation to the support structure (1) and the bicycle carrier comprising means for adjusting the angular position of the pivoting branch (2a, 2b) in relation to the structure of the support (1). The invention applies to bicyce carriers which can, in particular, be fixed to the rear part of a motor vehicle.

The present invention relates to a bicycle carrier comprising a support structure for at least one bicycle and attachable to a vehicle by two anchoring means, each at the end of a branch connected at its other end to the support structure.

This bicycle carrier will have particular application for bicycle carriers of the type fixable to the rear end of an automotive vehicle.

Conventionally configured to be positioned on the roof of automotive vehicles, bicycle carriers have undergone great improvement in recent years. In particular, it is increasingly widespread to provide bicycle carrying devices positionable at the rear end of the vehicle and particularly the level of a vehicle tailgate.

In the field of bicycle carriers borne on the rear of vehicles, there is known from the document BE 1 006841A3, a bicycle carrying device comprising a frame with pairs of uprights parallel to each other. These uprights are connected by a crosspiece provided with hooks adapted to hook to the upper edge of the tailgate of the vehicle. The uprights are then inserted in other uprights which, in the lower portion, are also connected by a crosspiece. As for the first crosspiece, the second crosspiece is provided with hooks which apply to the lower edge of the tailgate of the vehicle. Moreover, the two types of uprights, coact such that the one slides in the other. The bicycle carriers comprise moreover devices for blocking so as to hold the hooks engaged in the upper edges and lower edges of the tailgate of the vehicle and this by blocking the relative translation of the different uprights.

According to this prior art, the bicycle carrying device is held secured to the vehicle by gripping with a vise in which the distance separating the lower and upper hooks is progressively shortened by straight line movement so as to obtain good gripping.

The first drawback of this type of device is that the gripping permitting the securement of the device on the vehicle takes place by a manual operation giving rise to a weak gripping force.

Moreover, such a gripping operated by rectilinear movement of the two tubes, implies the provision of a relatively flat bicycle carrier such that the upper and lower anchoring zones and the tubes will be substantially in the same plane. In the contrary case, the structure is strongly urged to bend, which is less advantageous for embodiments comprising tubes.

Moreover, the relatively flat devices are not adaptable to all types of vehicles and particularly when an important contour is present at the rear of the vehicle.

Another drawback of the mentioned previous device is that the locking in gripped position takes place in a manner that is not easy.

The present invention proposes an alternative to the securement devices of bicycle carriers on vehicles using holding in position by gripping by translatory movement.

In this connection, the present invention has the advantage of providing holding in position of the bicycle carrier by a movement of rotation of two parts of the bicycle carrier.

According to this arrangement, the gripping effected by the user is much more efficacious, because it benefits from the gripping couple which can be great, particularly while keeping a good distance between the operation zone of rotation and the anchoring zones.

Moreover, by the use of pivotal connections, the constituent numbers of the bicycle carrier operate principally in traction, which facilitates their design and decreases the risk of breaking or damage.

Another advantage of the invention is, according to a preferred embodiment, to permit an adjustment of the gripping of the device by actuation of a rotatable handle and which is therefore particularly easy to use.

Other objects and advantages will become apparent from the description which follows, which sets forth a preferred embodiment of the invention which however is not limiting.

The present invention relates to a bicycle carrier comprising a support structure for at least one bicycle, attachable to a vehicle by two anchoring means each at the end of a branch connected at its other end to the support structure, at least one branch being mounted pivotally relative to the support structure and the bicycle carrier comprising means for adjusting the angular position of said pivotal branch relative to the support structure.

According to preferred embodiments, the bicycle carrier is such that:
the other branch is mounted pivotally relative to the support structure,
the support structure comprises a bearing surface adapted to be applied against the vehicle,
it comprises two other anchoring means on two other branches each forming one pair of anchoring means and of branches with one of the two first anchoring means and one of the two first branches,
the anchoring means are hooks,
the adjustment means have a helicoidal slideway, controlled in rotation, between the pivoting branch and the support structure,
the control in rotation is effected by a rotatable handle provided with a device for blocking in rotation,
the pivoting branch is adjustable as to length.

The accompanying drawings are given by way of example and are not limiting of the invention. They represent only an embodiment of the invention and permit its easy comprehension.

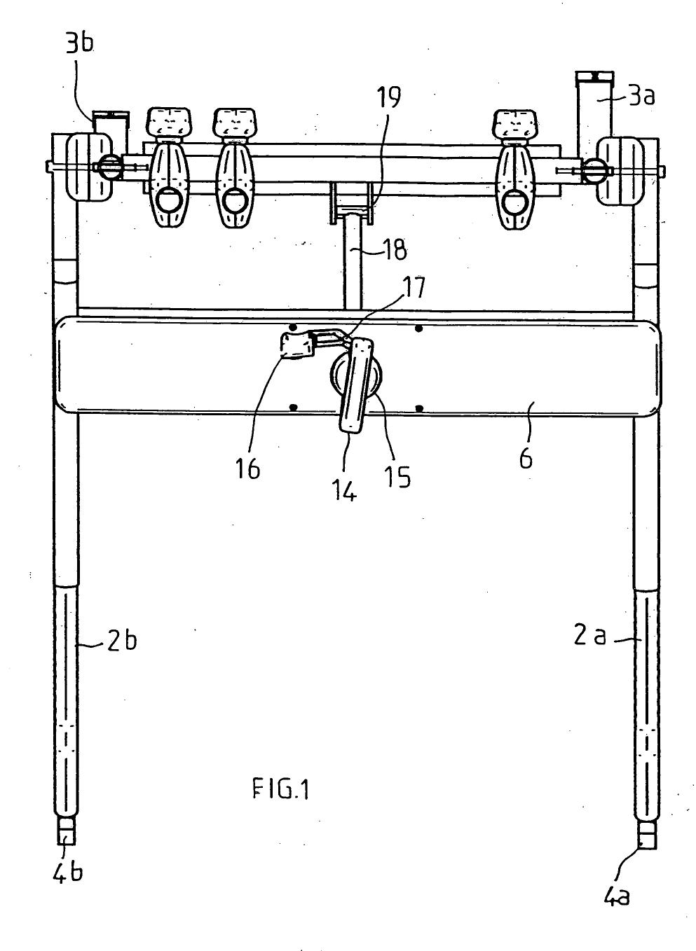

FIG. 1 is a front view of the bicycle carrier according to the invention in a preferred embodiment.

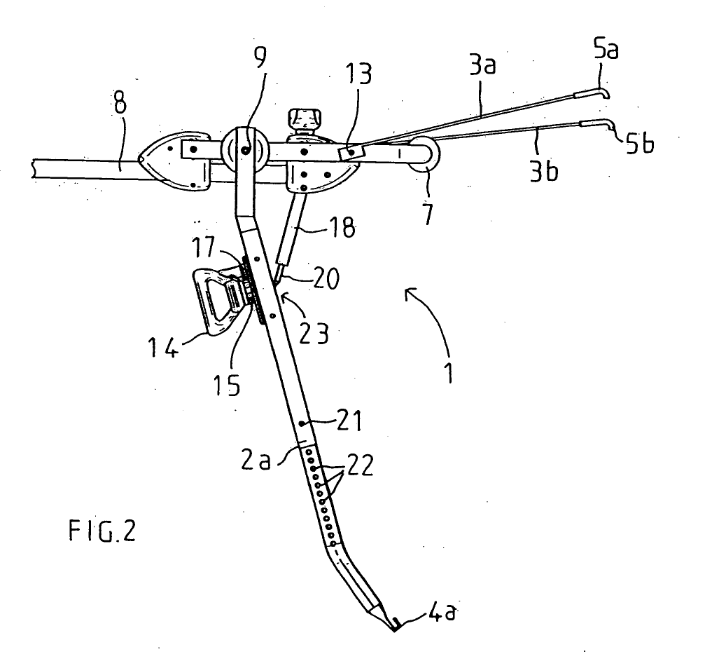

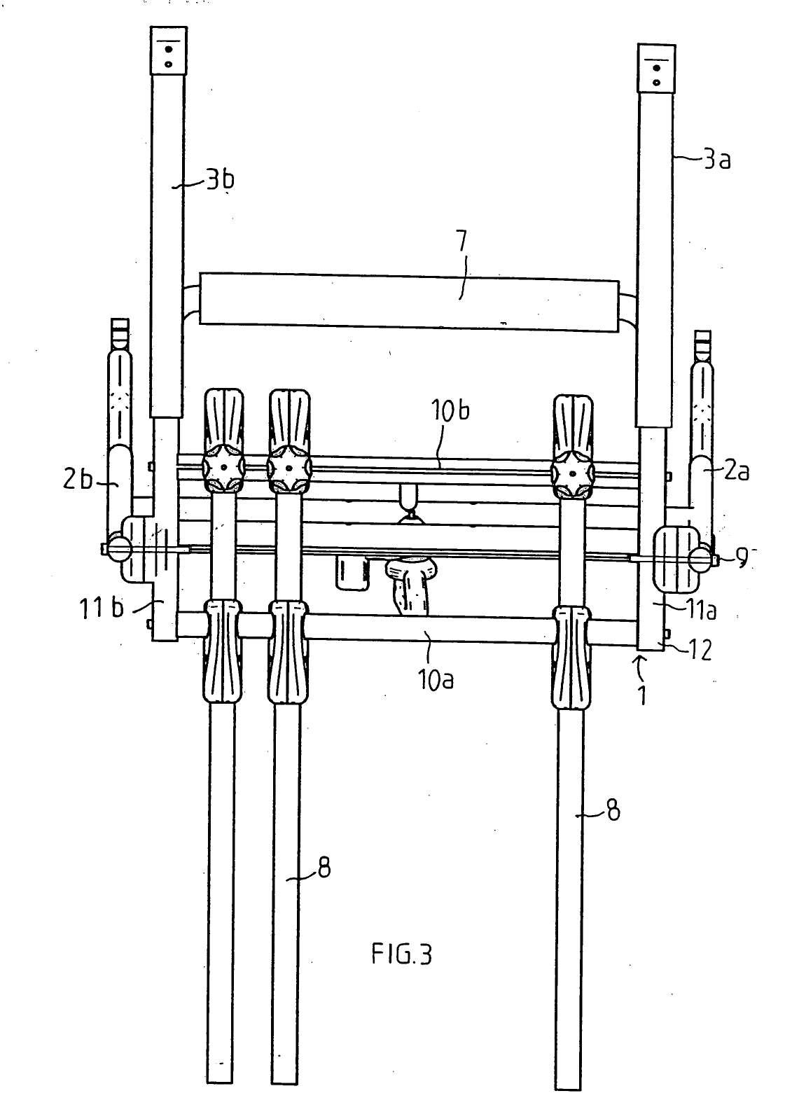

FIGS. 2 and 3 are respectively a side view and a top plan view.

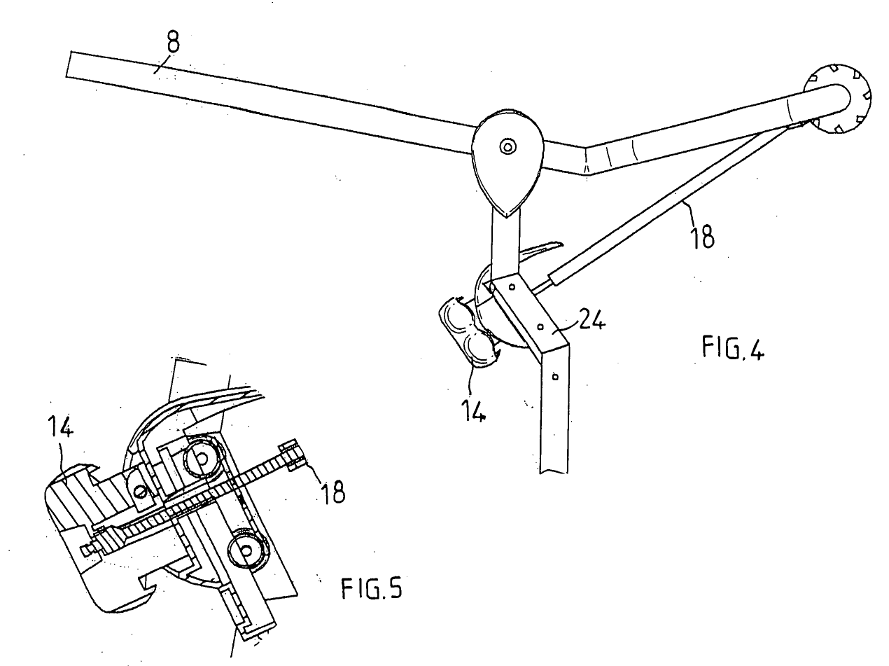

FIG. 4 shows another embodiment of the invention.

FIG. 5 is a partial cross-section, at the level of the handle.

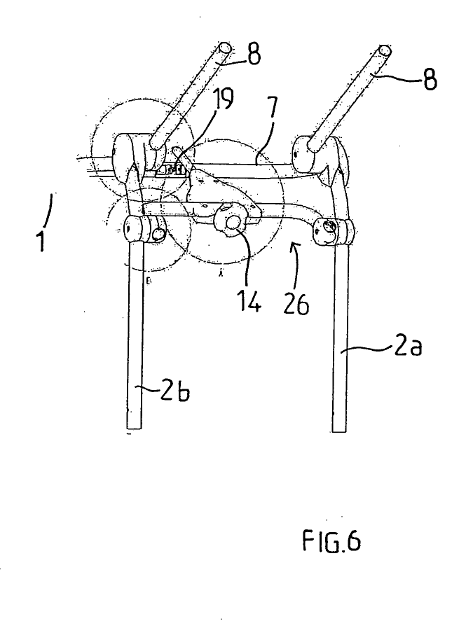

FIG. 6 shows a perspective view of another embodiment of the invention.

FIG. 7 is an exploded view.

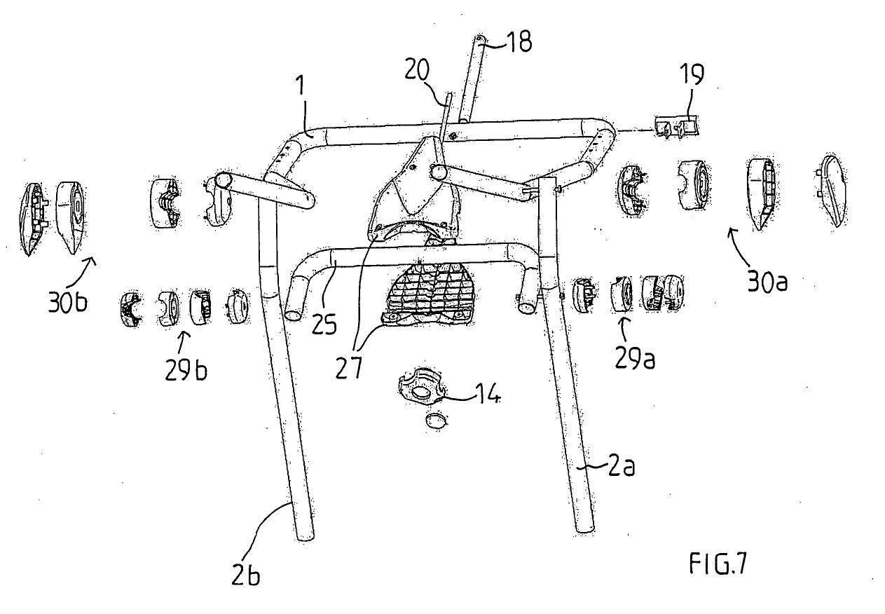

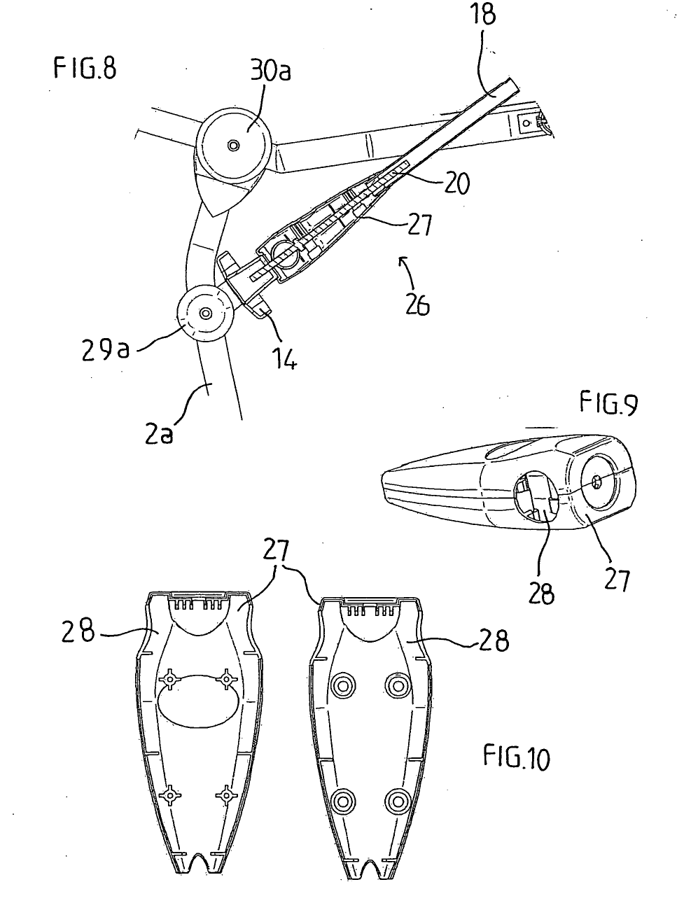

FIG. 8 is a view in partial cross-section.

FIGS. 9 and 10 show a particular element of the invention in the second embodiment illustrated.

Referring to FIG. 1, there will be seen a bicycle carrier comprising essentially an assembly of pieces in the form of bars or tubes, although this configuration is not limiting of the invention.

The bicycle carrier comprises anchoring means adapted to coact with a portion of the vehicle, preferably, on the one hand, in the upper portion of the vehicle and, on the other hand, in the lower portion of the vehicle. In particular, hooks 4a, 4b positioned in the lower region of the bicycle carrier could coact with the vehicle at this level on hooks 5a, 5b positioned in the upper region of the bicycle carrier could coact with the upper portion of the vehicle.

The bicycle carrier proposed here comprises moreover a support structure 1 permitting the support and holding of at least one bicycle.

As shown in the drawings and particularly in FIG. 3, this structure of support 1 comprises preferably a frame 12 formed by two longitudinal bars 11a, 11b interconnected by crosspieces in the form of transverse bars 10a, 10b.

The frame 12 also comprises preferably a bearing surface 7 at its end opposite that for holding bicycles, the bearing surface 7 being adapted to be applied against a portion of the vehicle.

The frame 12 receives one or several hooking bars 8 projecting rearwardly of the vehicle to receive bicycles to be transported.

The hooks 4a, 4b and 5a, 5b are connected to the support structure 1 by means of branches, respectively lower branches 2a, 2b and upper branches 3a, 3b.

The term “branch” means in its widest sense, namely, any member adapted to extend from the support structure (1) toward the anchoring means to interconnect them mechanically. It could particularly be a matter of bars, tubes, mechanically welded structures, flats, rods . . . .

It is to be noted that the number of hooks and of branches receiving them is not limiting but there will be at least one hook and one lower branch and one hook and one upper branch.

In addition to a free end receiving the hooks 4a, 4b, 5a, 5b, the lower and upper branches 2a, 2b, 3a, 3b comprise a second end connected to the support structure 1.

With reference to the drawings, there will be described hereafter a preferred embodiment with two lower branches 2a, 2b forming a pair of branches and two upper branches 3a, 3b forming another pair. However, the present invention can be practiced with a single lower branch and a single upper branch.

The lower branches 2a, 2b are connected by a pivot at the level of an axle 9 to the support structure 1.

Moreover, as is particularly shown in FIG. 2, adjustment means for the angular position of the lower branches 2a, 2b are present between said lower branches 2a, 2b and the support structure 1.

The adjustment means could for example be comprised by means of a connection member 26 provided with a helicoidal slideway comprising a screw-threaded bored tube 18 coacting with a screw-threaded rod 20 adapted to be controlled in rotation by a rotating handle 14.

The operator giving rotative movement to the handle 14 gives rise to rotation of the rod in the tube 18 and thus transforms the rotative movement into a translatory movement adapted to reduce the angle of the lower branches relative to the support structure 1.

At the opposite end of the handle 14, the slideway is mounted on the structure 1 by a securement 19 having preferably a freedom of movement in rotation.

Preferably, the upper branches 3a, 3b are also mounted pivotally relative to the structure 1. To this end, pivotal axes 13 are shown in FIG. 2.

It is possible that the axis of rotation of the rotatable handle 15 should be substantially different from the axis of translation of the helicoidal slideway formed by the combination of tube 18 and screw-threaded rod 20. According to this arrangement, it will be necessary to provide a system of angle change 23 between the handle 14 and the slideway. By way of example, the angle change 23 can be operated by a flexible portion connected the two pieces movable in rotation or else by means of a cardan joint.

Returning now to FIGS. 4 and 5, there is shown another embodiment of the invention in which the axis of rotation of the rotatable handle 14 is brought more into an alignment with that of the slideway. To do this, the handle 14 is carried by an inclined plane 14 whose inclination is adapted to the desired angle for the axis of the handle.

FIGS. 6 to 10 show still another embodiment of the invention.

In these figures, the connection member 26 connects the support structure 1 and the branches 2a, 2b, and has a bar 25 for connecting said connection member 26 to each of the branches 2a, 2b.

There could in particular be used a bar 25 in the form of a tube bent at each of its ends to form a U shape connected by means of connection members 29a, 29b to each of the branches 2a, 2b.

At its opposite end, the connection member 26 also comprises a securement 19 of its end on the support structure 1.

In the case of use of a helicoidal slideway, the securement 19 is adapted to receive the end of the tube 18.

In a preferred way, and to adapt the orientation of the connection member 26 according to the relative angular positions of the branches 2a, 2b and of the support structure 1, the connection member 26 is mounted pivotally relative to the branches 2a, 2b and to the support structure 1. In particular, the relative pivot of the connection member 26 and the branches 2a, 2b can be effected by means of connection members 29a, 29b.

Again in a preferred manner, the connection member according to this embodiment comprises a body 27 preferably constituted in two portions forming half shells and adapted to receive, in their internal volume, the helicoidal slideway system.

Moreover, the handle 14 for controlling in rotation is connected to the body 27.

The body 27 is mounted on the bar 25 by means of a passage 28 passing through said body 27. It will be noted that the relative pivoting of the branches 2a, 2b and the connection member 26 can also be provided between the body 27 and the bar 25.

According to the embodiment shown in FIGS. 6 to 8, the pivot connection between the branches 2a, 2b and the support structure 1 is effected by connection pieces 30a, 30b shown in detail in particular in FIG. 7 and comprise, like the connection pieces 29a, 29b, of several assembleable elements secured on the tubes and of which two consecutive portions are pivotally mounted.

Again preferably, the lower branches 2a, 2b are adjustable in length to permit pre-adjustment of the securement of the bicycle carrier.

In particular, an adjustment of length by sliding two nesting tubes forming a lower branch 2a, 2b is possible. The holding in the desired relative position of the two tubes is effected by a lug system 21 coacting with holes 22 spaced along one of the tubes.

The bicycle carrier according to the invention is very easy to use.

In the first instance, the user positions the hooks 5a, 5b, 4a, 4b on the corresponding portions of the vehicle. If necessary, an adaptation of the length of the lower branches 2a, 2b is first carried out.

When the bicycle carrier is thus pre-positioned, the operator actuates the handle 14 so as to proceed with gripping. During this operation, the operator tends to decrease the angle formed by the lower branches 2a, 2b and the support structure 1.

When the gripping is sufficient, the operator need only stop the movement of rotation of the handle 14.

Preferably, and for security, a blocking device is provided in coaction with the handle 14. In this way, there is avoided any untimely loosening of the bicycle carrier in the course of transport.

A blocking device in the form of a toothed wheel 15 secured to the handle 14, and coacting with a latch 16 whose finger 17 is adapted to be applied to the teeth of the wheel 15 to form an abutment in one direction of rotation, can be provided.

During disassembly of the bicycle carrier, it suffices to free the latch 16 to actuate the handle 14 in the reverse direction and to loosen the bicycle carrier.

It thus suffices to disengage the hooks 4a, 4b, 5a, 5b from the vehicle to complete the removal.

### REFERENCES

1. Support structure
2a, 2b. Lower branches
3a, 3b. Upper branches
4a, 4b. Hooks
5a, 5b. Hooks
6. Crosspiece
7. Bearing surface
8. Hooking bar
9. Pivot
10a, 10b. Transverse bars
11a, 11b. Longitudinal bars
12 Frame
13 Pivot
14 Handle
15 Wheel
16 Latch
17 Finger of the latch
18 Tube
19 Securement
20 Screw-threaded rod
21 Lug
22 Hole
23 Angle adjustment
24 Inclined panel
25 Bar
26 Connecting member
27 Body
28 Tube passage
29a, 29b. connection member
30a, 30b. Connection member

1. Bicycle carrier comprising a support structure (1) for at least one bicycle, connectable to a vehicle by two anchoring means each at the end of one branch (2a, 2b, 3a, 3b) connected at its other end to the support structure (1), characterized by the fact that at least one branch (2a, 2b) is pivotally mounted relative to the support structure (1) and that the bicycle carrier comprises means for adjusting the angular position of said pivoting branch (2a, 2b) relative to the support structure (1).

2. Bicycle carrier according to claim 1 characterized by the fact that the other branch (3a, 3b) is pivotally mounted relative to the support structure (1).

3. Bicycle carrier according to claim 1 characterized by the fact that the support structure (1) comprises a bearing surface (7) adapted to be applied against the vehicle.

4. Bicycle carrier according to claim 3 characterized by the fact that it comprises two other anchoring means on two other branches (2b, 3b) each forming a pair of anchoring means and branches with one of the first anchoring means and one of the two second branches (2a, 3a).

5. Bicycle carrier according to claim 1 characterized by the fact that the anchoring means are hooks (5a, 5b, 4a, 4b).

6. Bicycle carrier according to claim 1 characterized by the fact that the adjustment means comprise a connection member (26) of adjustable length between the support structure (1) and the branch or branches (2a, 2b).

7. Bicycle carrier according to claim 6 characterized by the fact that the connection member (26) has a helicoidal slideway (18, 20), controlled in rotation, between the pivoting branch (2a, 2b) and the support structure (1).

8. Bicycle carrier according to claim 7 characterized by the fact that the control in rotation is operated by a rotatable handle (14).

9. Bicycle carrier according to claim 8 characterized by the fact that the handle (14) comprises a device for blocking in rotation.

10. Bicycle carrier according to claim 6 characterized by the fact that the connection member (26) is pivotally mounted relative to the branch or branches (2a, 2b).

11. Bicycle carrier according to claim 6 characterized by the fact that the connection member (26) is pivotally mounted relative to the support structure (1).

12. Bicycle carrier according to claim 6 in combination with claim 3 characterized by the fact that the connection member (26) comprises a bar (25) whose ends are connected to the branches (2a, 2b).

13. Bicycle carrier according to claim 1 characterized by the fact that the pivoting branch (2a, 2b) is adjustable in length.

14. Bicycle carrier according to claim 2 characterized by the fact that the support structure (1) comprises a bearing surface (7) adapted to be applied against the vehicle.
